(19) United States
(12) Patent Application Publication
(10) Pub. No.: US 2014/0253505 A1
(43) Pub. Date: Sep. 11, 2014

(54) SYSTEM FOR PROTECTING PIN DATA WHEN USING TOUCH CAPACITIVE TOUCH TECHNOLOGY ON A POINT-OF-SALE TERMINAL OR AN ENCRYPTING PIN PAD DEVICE

(71) Applicant: CIRQUE CORPORATION, Salt Lake City, UT (US)

(72) Inventors: Paul Vincent, Kaysville, UT (US); Keith L. Paulsen, Centerville, UT (US); Jared G. Bytheway, Sandy, UT (US)

(73) Assignee: CIRQUE CORPORATION, Salt Lake City, UT (US)

(21) Appl. No.: 14/281,747

(22) Filed: May 19, 2014

Related U.S. Application Data
(62) Division of application No. 13/442,784, filed on Apr. 9, 2012, now abandoned.
(60) Provisional application No. 61/473,553, filed on Apr. 8, 2011.

(51) Int. Cl. G06F 3/044

(52) U.S. Cl. CPC G06F 3/044
USPC 345/174

(57) ABSTRACT

A system and method for providing security for a point-of-sale (POS) terminal or an encrypting PIN pad (EPP) by protecting the signals that could be directly probed on a touch sensor electrode grid or remotely probed such as through power supply signals or RF emissions, wherein the drive signals are randomly applied to drive electrodes in order to prevent tracking of drive signals, and charge is injected on sense lines to hide PIN data.

### CROSS REFERENCE TO RELATED APPLICATIONS

This document claims priority to and incorporates by reference all of the subject matter included in the provisional patent application docket number 4944.CIRQ.PR, having Ser. No. 61/473,553, filed Apr. 8, 2011.

### BACKGROUND OF THE INVENTION

1. Field of the Invention

This invention relates generally to touch sensor technology. Specifically, the invention is related to the ability to configure a touchpad or touchpad detection circuitry such that side channel touch position data leakage is minimized to provide better immunity to PIN discovery using a power analysis attack.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function. The present invention is also applicable to single layer projected capacitance touch sensor designs using only a single axis of electrodes. The present invention is also applicable to surface capacitance and resistive touch sensors.

With this understanding of one capacitance sensitive touchpad, it is now possible to discuss the present invention and a particular application because of shortcomings in state of the art designs.

A problem that has arisen in point-of-sale (POS) devices is that they are vulnerable to tampering, insertion of a PIN disclosing bug, and to side channel power analysis attack. The stealing of credit card information is on the rise and is a substantial cause of concern among consumers. Accordingly, there is a substantial benefit from making devices more secure that read confidential data from credit and debit cards that can be used to access accounts.

For example, there are many electronic devices that are used to read data stored on credit or debit cards. Most of these devices read information from a magnetic strip. However, other electronic devices read information from newer smart cards using radio frequency signals. Both of these types of electronic devices then enable a user to input a secret Personal Identification Number (PIN) in order to complete a transaction. The PIN is typically entered on a PIN Entry Device (PED). Vulnerabilities in the design of PEDs show that these vulnerabilities can be exploited using unsophisticated techniques to expose PINs, credit and debit card numbers and other cardholder data.

One method of obtaining PIN information is to detect PIN data as it is being entered from a keypad on the PED. CIRQUE® has already developed and described intrusion detection technology for protecting the enclosure or the cage around the touch and data entry technology. This technology is used to provide a PED that would be able to detect the presence of a foreign object, such as a sensor designed to detect input without interfering with the process of providing input to the PED, wherein the input is typically confidential information.

However, it would be a further advantage to provide protection technology that is focused on the sensor electrodes and the communication between a sensor chip and a processing chip that is providing encryption services.

In cryptography, a side channel attack is any attack based on information gained from the physical implementation of a cryptosystem. For example, timing information, power consumption, electromagnetic leaks or even sound can provide an extra source of information which can be exploited to break a system. Some side-channel attacks require technical knowledge of the internal operation of the system on which the cryptography is implemented, although others such as differential power analysis (DPA) are effective as black-box attacks.

Power analysis attack can provide even more detailed information by observing the power consumption of a hardware device such as a CPU or cryptographic circuit. These attacks are roughly categorized into simple power analysis (SPA) and differential power analysis (DPA). SPA involves visually interpreting power traces, or graphs of electrical activity over time. DPA) is a more advanced form of power analysis which can allow an attacker to compute the intermediate values within cryptographic computations by statistically analyzing data collected from multiple cryptographic operations.

### BRIEF SUMMARY OF THE INVENTION

The present invention is a system and method for providing security for a point-of-sale (POS) terminal or an encrypting PIN pad (EPP) by protecting the signals that could be directly probed on a touch sensor electrode grid or remotely probed such as through power supply signals or RF emissions, wherein the drive signals are randomly applied to drive electrodes in order to prevent tracking of drive signals, and charge is injected on sense lines to hide PIN data.

In a first aspect of the invention, a flip-chip design is used to create a multi-chip-module (MCM) that is disposed directly on to a glass substrate.

In a second aspect of the invention, frequency hopping is used to obscure signals on the sensor electrode grid.

In a third aspect of the invention, continuous injection of charge on sense lines through obscuring capacitors or other charge injection circuitry is used to hide PIN data.

In a fourth aspect of the invention, continuous variation of sense offset is used to hide PIN data.

In a fifth aspect of the invention, randomized or continuous variation of electrode patterns are used on the drive electrodes to hide PIN data.

In a sixth aspect of the invention, secret, random or pseudo-randomly generated values, known only to the touch measurement system, are used to produce continuous variation of touch sensor drive and sense signal parameters including but not considered as limited to: amplitude, offset, phase, input impedance, output impedance, pre-charge and timing.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a prior art schematic diagram of a touchpad.

FIG. 2 is a diagram of the components of a typical point of sale terminal with an encrypting PIN pad.

FIG. 3 is a profile cut-away view of a touch screen or touchpad having a glass substrate, a sensor electrode grid and a flip-chip mounted touch sensor integrated circuit.

FIG. 4 is a perspective and exploded view of an XY electrode grid showing the electrodes in a single plane and arranged orthogonally with respect to each other.

FIG. 5 is a close-up view of a drive set of electrodes coupled to a touch sensor IC.

FIG. 6 is a profile cut-away view of a touch screen or touchpad having a glass substrate, electrode grid and a separate substrate for the touch sensor ICs, coupled via a tail between the electrode grid and touch sensor ICs.

FIG. 7 is a circuit diagram of a first embodiment of a circuit that is used to hide the signal being received on a sense line.

FIG. 8 is a circuit diagram of a second embodiment of a circuit that is used to hide the signal being received on a sense line.

FIG. 9 is a circuit diagram of a third embodiment of a circuit that is used to hide the signal being received on a sense line.

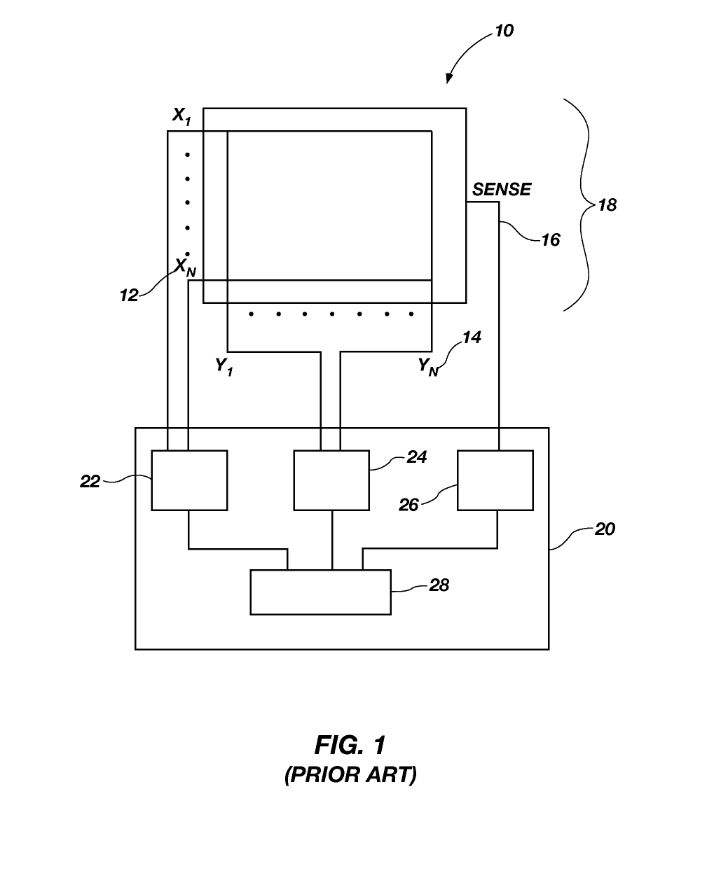

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

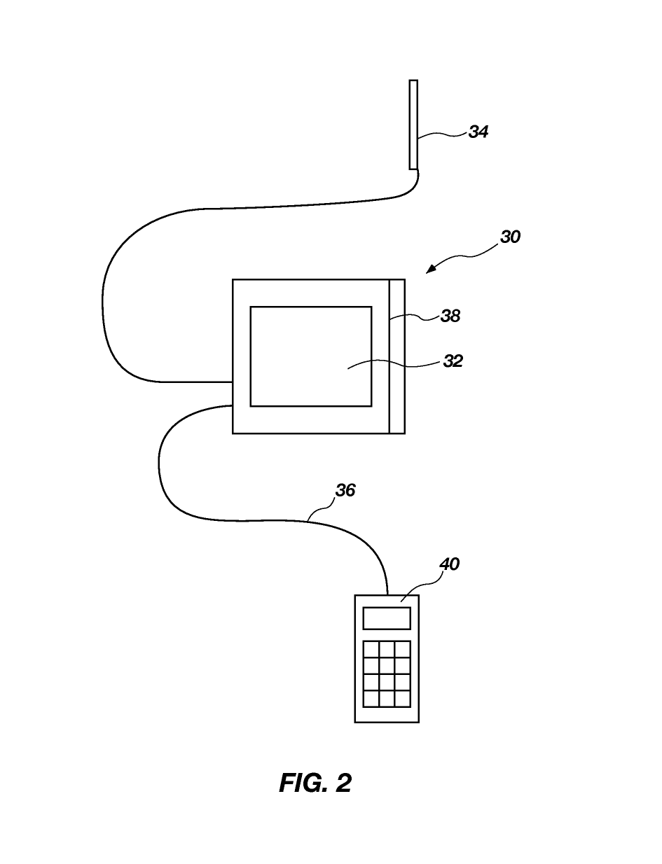

The present invention is a system for securing Personal Identification Number (PIN) data entry at a point of sale. A point of sale (POS) terminal 30 is shown in FIG. 2. The POS terminal 30 may have a slot 38 for swiping a credit, debit or other financial access card. The POS terminal 30 will also have a means for capturing a signature or the PIN, so will have some combination of a screen such as a touch screen 32 for data entry, and a stylus 34 for entry of a signature on the touch screen and/or for entry of a PIN. The POS terminal 30 may have a physical keyboard or a virtual keyboard (not shown) on the touch screen 32 for entry of the PIN. The POS terminal 30 may also include an Encrypting Pin Pad (EPP) device 40 that is separate from the POS terminal but coupled to it by a communication link 36. The EPP device 40 may have a display screen, a touch and display screen, a physical keypad, a touch or virtual keypad, or any combination of these displays and keypad.

It should be understood that the POS terminal 30 can be configured with various combinations of display screens, RFID readers, stylus pens and keypads for entry of a customer's financial information so that a transaction can be performed. The POS terminal 30 and other devices shown in FIG. 2 are for illustration purposes only and should not be considered to limit the scope of the present invention. It is also noted that the EPP device 40 can also be coupled directly to a cash register by itself or in combination with the POS terminal 30.

EPPs form a component of unattended PIN Entry Devices (PEDs). Typically, EPPs are used to enter a cardholder's PIN in a secure manner. For the purpose of this document, an EPP is considered to consist only of a secure PIN entry device. EPPs are typically used in conjunction with cash registers, ATMs, automated fuel dispensers, kiosks, and vending machines.

The present invention is a combination of security features that are designed to protect PIN entry. It is recognized that any system for PIN entry and then subsequent use in a financial transaction has several vulnerabilities because of the nature of the process. The present invention addresses several different types of vulnerabilities.

This first embodiment of the present invention is directed at the integrated circuit or circuits (ICs) that analyze touch information received from a touch screen on a POS terminal 30 or an EPP device 40. It will be assumed that the touch screen is being used to enter PIN data. This first embodiment of the present invention is the application of CIRQUE® technology to create a secure touch screen on the POS terminal 30 or the EPP device 40.

As shown in a profile and cut-away view in FIG. 3, single or multiple integrated circuits 56 are used for capacitive touch sensing for PIN entry detection on the touch screen 32. The touch screen 32 has a touch sensitive surface 52 and an opposite non-touch side 54 that is disposed within a housing of the POS terminal 30 or the EPP device 40. Disposed on the non-touch side 54 is an electrode grid 58 that is comprised of the X and Y electrodes used for driving and receiving signals that are used to detect the presence and location of a finger on the touch screen 32. In the present invention, the touch sensor ICs 56 are disposed on the non-touch side 54 of the glass being used for the touch screen 32.

Disposing the touch sensor ICs 56 on the non-touch side 54 of the touch screen 32 is referred to as a flip-chip design which enables the touch sensor ICs 56 to be disposed directly on glass, and thereby eliminating any other substrate that would otherwise be used for mounting of the touch sensor ICs 56. By turning the touch sensor ICs 56 over (flipping the integrated circuit chips) and then mounting the touch sensor ICs directly on non-touch side 54 that is directly opposite the touch sensitive surface 52, the security for a POS terminal 30 or EPP device 40 is increased because there are no communication lines between the electrode grid 58 and the touch sensor ICs 56 that can be probed. In other words, instead of having small wires or pins that are project from the sides of the ICs 56, the contacts between the ICs and the electrodes grid 58 are directly underneath the ICs, between the ICs and the glass. This flip-chip design makes it difficult if not impossible for a probe to be inserted between the ICs and the glass in order to make contact with the contacts.

The object of the present invention is therefore to put the touch sensor ICs 56 as close to the electrode grid 58 as possible, while eliminating points of weakness that could be exploited by being probed for data.

The touch sensor ICs 56 that are being referred to for use in the flip-chip design are any data sensors and processors that are needed for receiving and processing touch input for PIN entry. The creation of the touch sensor ICs 56 that can be used for secure PIN entry are also referred to as a Multi-Chip Module (MCM), but should not preclude the combination of all the MCM technology into a single chip design if so desired. The creation of the MCM is part of a total system that is referred to as a Tamper Resistant Security Module (TRSM) which is the combination of the MCM and any security measures being implemented to secure PIN entry.

In another embodiment of the invention shown in FIG. 6, the electrode grid 58 is disposed on a glass substrate 50 being used as the touch screen 32, which has a touch sensitive surface 52 on one side, and wherein the electrode grid 58 is disposed on the opposite non-touch side 54 that has the touch sensor electrode grid. What is different from the first embodiment is the use of a tail 60 that serves as a substrate for electrodes that allow signals to travel between the electrode grid 58 and the touch sensor ICs 56. Instead of the touch sensor ICs 56 being disposed directly on the non-touch side 54, a touch sensor IC substrate 62 is provided. The object of this embodiment is to prevent communication between the electrode grid 58 and the touch sensor ICs 56 from being intercepted and probed by eliminating any distance between the electrode grid and the touch sensor ICs.

The description above is directed to a method for mounting the sensor and processing integrated circuits that are used to detect PIN entry in a POS terminal 30 or an EPP device 40 in such a way as to prevent access to any communication links to the XY electrode grid. The next aspect of the present invention is directed at signals.

An important aspect of a first embodiment of the present invention that is important to understand how the signals of the present invention are being modified and thereby protected from data leakage. There are two ways in which signals are being modified. The first way in which signal modification is performed is by modifying a signal by decreasing signal strength and increasing noise. In other words, the signal to noise ratio is increased to hide the signal. There are many ways to do this, and many examples will be given hereinafter. The signals can be modified in amplitude, offset, phase, input impedance, output impedance, pre-charge and timing in the time domain or they are modified in the frequency domain.

Obvious choices for increasing a signal to noise ratio and affecting signal amplitude is by using spread spectrum techniques such as CDMA and OFDM. Other techniques for modifying signals are using balanced patterns or phase cancellation from STOMP, using offsets for adding or subtracting values from sense signals, changing the input impedance of the sense electrodes, and changing the output impedance of the drive electrodes. However, the present invention should be assumed to include all the ways in which the signal amplitude can be decreased while increasing the amplitude of the noise, and the lists above should not be considered as excluding other ways.

The signal modification methods listed above can all be used to modify signals. Nevertheless, a determined attacker could monitor the signals long enough and determine how the signals are being modified. Thus it is necessary to perform the actual signal modification in a way that hides how the methods of parameter modification are being performed. The second way in which signal modification is performed is through cryptography, or cryptographic techniques. The specific cryptographic techniques being used are known to those skilled in the art. It is the application of cryptographic techniques to the present invention that enables the present invention to function. Thus, when random or pseudo-random values are being generated to modify parameters of the touch sensor, these values are kept secret within the touch sensor, thereby preventing an attacker from learning how the parameters are being changed.

Another aspect of the embodiment is that the values being generated to change the touch sensor parameters can be generated once or can be generated continuously, depending upon the nature of the parameter that is being changed. For example, if the parameter is temporal and requires many new random or pseudo-random values, they can be generated continuously as rapidly as needed.

Consider the example of using CDMA to increase the signal to noise ratio. If an attacker does not know the sequence that the CDMA is walking through, and the attacker cannot derive it, then data leakage is prevented even if the signal can be probed.

In other words, consider any parameter that can be varied, both input and output. If the parameter is being varied continuously and in such a way that the attacker does not have access to how the parameter is being changed, and this method of variation of the parameter is known only to the touch measurement system, then this embodiment can be used to produce continuous variation of touch sensor drive and sense signal parameters that are secure from data leakage. These touch sensor parameters that are being varied include, but should not be considered to be limited to: amplitude, offset, phase, input impedance, output impedance, pre-charge and timing.

Because the touch sensor system knows how the parameter is being varied, the first embodiment can undo the signal modifications or in other words “pull” the signal from the modified signal and be used to obtain the actual signal from the touch sensor. It is assumed that signals from the touch sensor can be probed. Thus, if the signals are modified in such a way that the attacker cannot determine how the signals have been altered, then it is irrelevant that the signals are vulnerable to being probed.

For example, the attacker does not know if the signal being probed has been modified with some random or pseudo-random offset, or any other signal modification method. But because the attacker can't determine how the signal has been modified, and won't be able to determine how the signal has been modified because the parameter is continuously being modified, then the attacker cannot obtain useful information from the touch sensor.

Turning now to specific examples of how touch sensor parameters can be modified, this document first examines the drive signals that are being driven on the electrode grid 58 and the signals received therefrom. Security is necessary because an attempt could be made to monitor signals to and from the electrode grid 58 which would divulge PIN data. Therefore, the next aspect of the invention is directed to protection of the electrode grid 58 when stimulus or drive signals are being transmitted.

Both traditional Mutual Capacitance controllers and Self-Capacitance controllers have electrically stimulated electrode patterns in order to determine touch location. These patterns are typically sequential and repeating. These patterns can be probed and decoded by a malicious device to gather data about the system such as finger position. Pseudo-random Numbers (PN) with orthogonal patterns can be used instead of sequential scanning patterns that obscure data but these typically repeat every frame (a set of measurements) and thus can also be probed.

It is an improvement over the state of the art if a probe that is trying to intercept signals to the electrode grid 58 does not know the order in which the drive electrodes are being driven. The embodiment is to randomize or vary the electrical stimulus of the sensor to thereby increase the difficulty of snooping or performing a side channel attack. By stimulating the drive electrodes of the electrode grid 58 in a random or varying manner, it is possible to prevent detection of PIN data that is being sent to the touch sensor ICs 56.

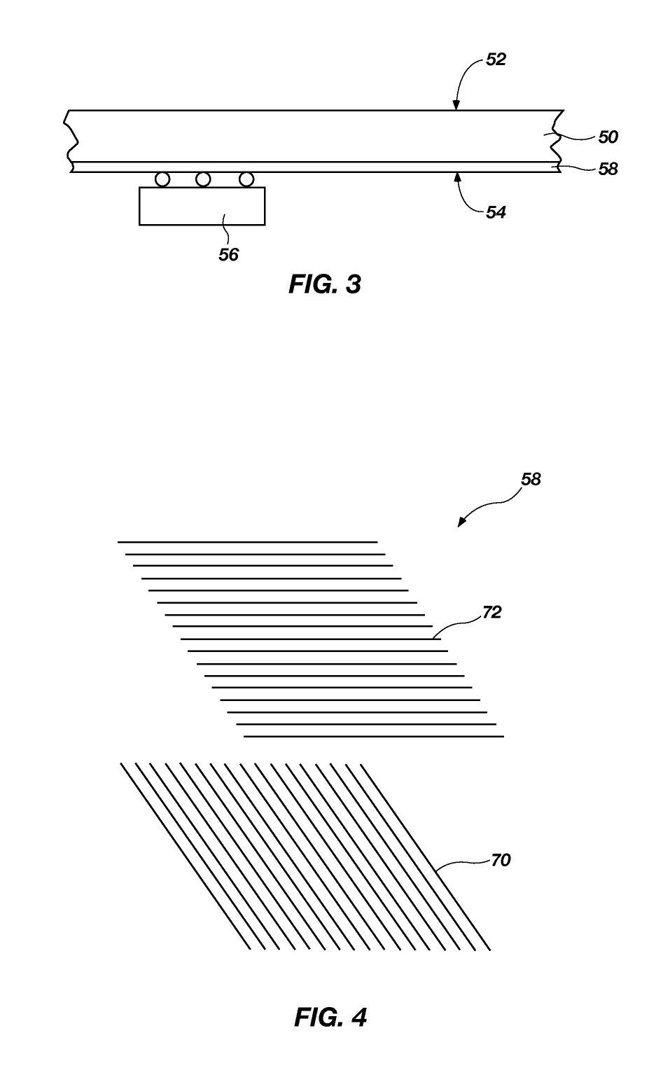

The first method of randomization is to randomize the order that the electrodes are stimulated in a measurement cycle. Consider a system of orthogonal but planar electrodes forming the electrode grid 58 as shown in FIG. 4. The electrodes are disposed in two parallel planes of X and Y electrodes 70, 72, where the X and Y designation are arbitrary. The X and Y electrodes 70, 72 alternate between functioning as a drive set 60 and a sense set 62. The distance between the X electrodes 70 and the Y electrodes 72 is exaggerated and is for illustration purposes only to demonstrate the physical relationship of the electrodes with one electrode grid 58 wherein one set of electrodes is disposed above the other.

This electrode grid 58 shows a typical arrangement of X and Y electrodes for the keypad of an EPP device 40 or a touch screen of a POS terminal 30. The X and Y electrodes 70, 72 alternate between functioning as drive electrodes (the drive set) and sense electrodes (the sense set) in order to determine the location of one or more objects on a touch sensitive surface. Thus, the technology is adaptable for use any touch sensor technology, but is especially useful in touchpad and touch screen applications. Not shown are the touch sensor ICs 56 that are coupled to the X and Y electrodes 70, 72.

The present invention also uses mutual capacitance to detect a change in capacitance between drive electrodes and sense electrodes caused by the introduction of one or more conductive or dielectric objects. It will be assumed that a typical object that will make contact with a touch sensitive surface of an EPP device 40 or a POS terminal 30 is going to be a person's finger. However, the object making contact could be a stylus made of a conductive or dielectric material. It will also be assumed that a typical object that will come in proximity with a touch sensitive surface of an EPP device 40 or POS terminal 30 is going to be a carbon pill or other conductive component of a switch or snap dome as in a keymat placed above the touch sensitive surface.

When performing a measurement cycle comprised of driving electrodes and then measuring a signal on the sense electrodes, the role of the electrodes is switched so that a location measurement is made in both the X and Y axes. After completing a measurement cycle, the drive set will typically switch roles with the sense set for the next measurement cycle. It is also noted that although grouping measurements into measurement cycles is useful for some applications, there is no requirement for fixed measurement set sizes or measurement cycles.

When the electrode grid 58 is going to be stimulated in a random pattern, each of the electrodes in the drive set may be driven once before any new measurement cycle is begun. In other words, if there are 12 drive electrodes 60, each one of the 12 drive electrodes may be driven with a stimulus signal at least one time for a given measurement cycle.

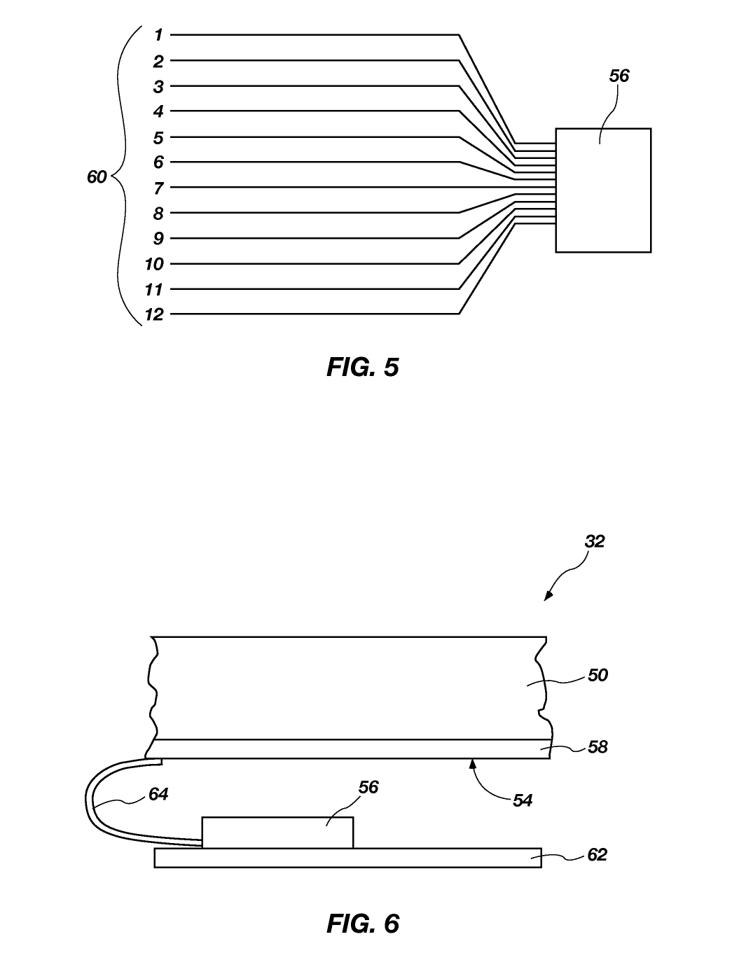

For example, referring to FIG. 5, the drive set 60 is shown from the electrode grid 58. Not shown is the corresponding sense set 70 that is disposed in a same plane but orthogonal to the drive set 60. The drive set 60 is shown coupled to the touch sensor ICs 56, which may be one IC or a plurality.

As each one of the electrodes in the drive set 60 is stimulated, some sort of table or list is used to track which of the electrodes have been stimulated, and which of the electrodes are still waiting for a stimulus signal. Driving each electrode of the drive set 60 and measuring the response on the sense set 70 is referred to as a single measurement cycle. After the measurement cycle is complete, all of the electrodes in the drive set 60 become eligible for stimulation again in a next measurement cycle.

An example of one complete measurement cycle might be to stimulate the drive set 60 in the following order: 4, 9, 3, 12, 11, 2, 6, 1, 5, 7, 8, and 10. The next time that this set of electrodes is the drive set 60, the stimulus order will be different. This example is for illustration purposes only. Each electrode is stimulated once and no electrode within the drive set 60 is repeated until the measurement cycle is complete.

Alternatively, it is possible that not all the drive electrodes would be stimulated with a drive signal in order to further confuse a probe.

It is important that the same pattern of stimulus signals to the drive set 60 should not be repeated except by chance in the next measurement cycle. In other words, a random or pseudo-random pattern of stimulus signals should be selected so that a person attempting to probe the drive set 60 will not be able to anticipate which one of the electrodes will be stimulated next. The only discernable pattern is that each electrode in the drive set 60 is stimulated only once until each electrode has been stimulated in a single measurement cycle, or in the alternative, that not all the electrodes are stimulated.

When the electrode grid 58 is going to be stimulated using randomized Synchronized Timed Orthogonal Measurement Patterns (STOMP), each of the electrode patterns in the drive set are used in a measurement cycle. In other words, if there are 12 drive electrodes 60, each one of the drive electrode patterns are used for a given measurement cycle. The list of electrode patterns in the drive set are permuted between measurement cycles.

As stated previously, it should be noted that measurement sets are for convenience and may consist of any number of measurements. It is also not an aspect of this invention that measurements patterns must be grouped into measurement cycles.

It is beneficial to a “report rate” to uniformly and randomly generate patterns and continuously compute and update touch locations with every measurement or interval of measurements. In this method, previously measured values associated with each measurement pattern are stored prior to being used in computations. Whenever the measurement pattern is repeated, the prior measured value is reversed from the computation and the new measured value is stored and inserted into the computation. In this way, information about the capacitive surface is updated and may be reported with every measurement and recalculation.

In an alternative embodiment, spread spectrum techniques can be used to introduce temporal noise to the system. Thus, what is randomized is the variation of time between measurement cycles. In another alternative embodiment, what is randomized is the variation of time between individual electrode stimulus events within a measurement cycle, or the time between measurements, or the time between measurement cycles, or the number of patterns in a measurement set. In other words, there are many time domain events that can be altered, and they are all considered to be within the scope of the present invention.

In another alternative embodiment, what is randomized is the variation of the stimulating voltage for each stimulus event.

The embodiments of the present invention described above are directed to the transmission of signals to the electrode grid 58. Another embodiment of the present invention is the protection of the signals being received from the sense set 70, or the electrodes in the electrode grid 58 that are serving as the sense electrodes for a particular measurement cycle.

Frequency hopping can be used to prevent probing of PIN data. Frequency hopping is a technique that is well known for preventing noise from interfering with operation of a touchpad. However, it is another embodiment of the present invention to use frequency hopping to stop a very common form of data probing.

To understand how frequency hopping can be used to prevent the interception of PIN data, a form of probing operation of a touch sensitive surface needs to be discussed. A Differential Power Analysis (DPA) attack is when an analysis is performed on the power usage of touch sensor ICs. Frequency hopping will be used to obscure to an outside observer the actual power usage of sense electrodes in the sense set 70. In other words, this technique can be used to essentially inject noise onto electrodes and thereby hide the actual PIN data that is being entered.

The present invention uses the concept of projected mutual capacitance to detect PIN entry data. However, PIN entry data can also be collected using self-capacitance technology. Projected Mutual Capacitance controller sensing inputs can be probed directly with a low capacitance scope probe or via an amplifier to observe the transients of the incoming signal. Self-Capacitance controller sensing inputs can be probed directly with a low capacitance scope probe or via an amplifier to observe the ramp rates of the sensing signal. Detection of the magnitude of touch interaction, location of touch interaction, and timing of touch interaction in relationship to stimulus may be derived by observing the voltage transients on the sensing inputs. The ability of an external system to observe the input signal of a system that was meant to be secure or private and derive the detection of the sensed object(s) will compromise its value as a secure input device.

The next embodiments of the present invention describe two methods for obscuring the detection and location of tracked objects. The first method is to change the voltage of the sense line from inside the controller chip where an outside observer cannot determine if the transients of signal on the sense line are due to the charge induced by the mutual capacitance on the sensor or from a circuit internal to the controller chip.

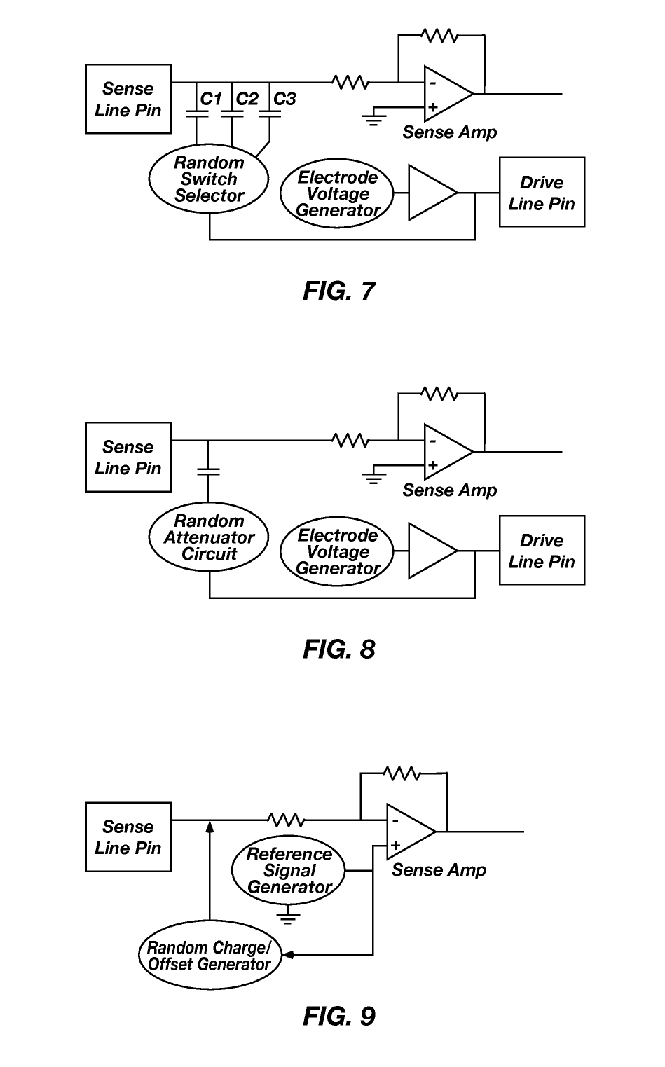

FIG. 7 is an example of a circuit that can be used to change voltage on sense lines in accordance with method one. FIG. 7 shows a circuit that will obscure the sensing signal primarily for a Projected Mutual Capacitance system. This method injects signal into the sense line(s) via an internal signal generator that is synchronous with the drive lines. The signal generator will induce transients in the voltage domain on the sense line that appear similar to transients found in typical usage. Random or pseudo-random amounts of charge would be injected into the sense line via the signal generator. This can be done by switching in various sized on-chip capacitors between the sensing electrodes and a signal matching the external electrodes.

FIG. 8 shows that in an alternative embodiment it is possible to use a fixed size capacitor that is connected to a circuit that shapes and scales the excitation signal synchronous to the external drive signal.

FIG. 9 shows that another method for obscuring the detection and location of tracked objects is to modulate the voltage of a plurality of sensing inputs so that they are identical in the voltage domain with internal sensing of objects in the current domain. FIG. 9 shows a circuit that will obscure the sensing signal primarily for a Self-Capacitance touch sensor system. This method randomly or pseudo-randomly changes the reference voltage or nominal voltage of the sense line for some interval that could also be random. The sensing circuit calibrates itself to the random offset and therefore is immune to any undesired effects of a varying reference voltage.

In an alternative embodiment of method two, another method of obscuring the input signal is to couple the random charge injection in a manner that the mean of the injected charge is equal to and opposite of the detected object so as to offset the inputs to appear as if the sensor were not being touched.

In summary, FIGS. 7 and 8 inject random signals that appear on the sense line to be very similar to typical or expected signals due to proximity of a finger on the sense line. In FIG. 7 the circuit selects the coupling capacitors of different values to vary the charge injected into the sensing circuit. In FIG. 8 the circuit varies the voltage level of the drive signal to the internal coupling capacitor. In FIG. 9, a modulating reference voltage of sense amplifier changes the nominal voltage out on the sense line input and its associated random charge and/or offset generator.

It is noted that when capacitors are coupled to the sense line, the capacitor can be pre-charged to a known amount or not. Whether or not the capacitor is pre-charged, connecting the capacitor through the switch will cause a change in impedance on the sense line.

Because the person probing the sense line does not know the amount of charge, if any, is being applied to the sense line, or if the impedance is being altered, it will be difficult to determine if the sense line is actually getting a signal that is indicative of the presence of a finger or not.

The capacitor can provide a known charge to thereby provide a known offset to the signal being measured. Because that offset is not known to the probe, and the amount of offset can be changed, the data from the sense lines is protected.

Another aspect of data protection is in defeating DPA attacks by keeping the power emissions of any touch sensing device as low as possible. Furthermore, when toggling a signal, it is important to toggle in both directions in order to obscure the meaning of a toggling event.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1-18. (canceled)

19. A method for preventing data that is probed from a touch sensor to provide actual touch information, said method comprising:
providing a touch sensor having a plurality of drive electrodes and a plurality of sense electrodes, wherein the plurality of drive electrodes stimulated one at a time with a drive signal and the plurality of sense electrodes are measured to determine touch information therefrom;
applying the drive signal to the plurality of drive electrodes in a random or pseudo-random pattern so that it is not possible to determine which of the plurality of drive electrodes has a real drive signal applied; and
extracting the touch information from the plurality of sense electrodes by knowing which of the plurality of drive electrodes received the real drive signal.

20. The method as defined in claim 19 wherein the method further comprises changing an offset voltage on the plurality of sense electrodes in order to add or subtract voltage from the plurality of sense electrodes and therefore hide real touch information on the plurality of sense electrodes.

21. The method as defined in claim 20 wherein the method further comprises using a plurality of capacitors to modify the offset voltage on the plurality of sense electrodes.

22. The method as defined in claim 20 wherein the method further comprises using a signal generator to modify the offset voltage on the plurality of sense electrodes.

23. The method as defined in claim 20 wherein the method further comprises using a circuit that shapes and scales an excitation signal synchronous to drive signal to modify the offset voltage.

24. The method as defined in claim 19 wherein the method further comprises injecting a signal on the plurality of sense electrodes in order to hide real touch information on the plurality of sense electrodes.

25. The method as defined in claim 20 wherein the method further comprises using a plurality of capacitors to inject the signal on the plurality of sense electrodes.

26. The method as defined in claim 20 wherein the method further comprises using a signal generator to inject the signal on the plurality of sense electrodes.

27. The method as defined in claim 20 wherein the method further comprises using a circuit that shapes and scales an excitation signal synchronous to drive signal to inject the signal on the plurality of sense electrodes.
